(19) United States
(12) Patent Application Publication
(10) Pub. No.: US 2003/0014243 A1
(43) Pub. Date: Jan. 16, 2003

(54) System and method for virtual localization of audio signals

(76) Inventor: Olivier D. Lapicque, Santa Clara, CA (US)

Correspondence Address: SIMON, GALASSO & FRANTZ PLC, P.O. BOX 26503, AUSTIN, TX, 78755-0503, US

(21) Appl. No.: 09/901,242

(22) Filed: Jul. 9, 2001

(51) Int. Cl. G10L 21/00

(52) U.S. Cl. 704/203

(57) ABSTRACT

A system and method for virtual localization and/or virtual motion of an audio signal are disclosed herein. The audio signal, represented by data such as an audio file, can be transmitted from an audio source, such as an MP3 player, to an audio processing system. The audio processing system, in one embodiment, buffers the audio data in a circular buffer. As the data is being buffered, one or more sample rate conversion units read data from the circular buffer and process the data to generate two or more unmodified channels. In one embodiment, data is read from a first buffer location of the circular buffer to generate a first unmodified channel, while at the same time, data is read from a second buffer location, different from the first buffer location, to generate a second unmodified channel. The difference between the two buffer locations, in one embodiment, is representative of a virtual inter-aural time delay. This virtual inter-aural time delay can be used by the human auditory system to give the unmodified channels, when converted to sound together, a “virtual location”. Similarly, a frequency modification process can be applied to either or all of the unmodified channels to generate localized channels which can produce a “virtual motion” effect. For example, in one embodiment, a Doppler effect modification is applied to each of the stereo channels to create the perception of motion of a sound source represented by the audio signal.

### FIELD OF THE DISCLOSURE

The present invention relates generally to processing audio signals and more particularly to the localization of sounds in three-dimensional space.

### BACKGROUND

Localization of audio signals in three-dimensional space proves useful for a number of applications. For example, by giving a sense of location and motion to the voices of the actors and sound effects (audio signals) of a movie played in a theatre, the viewers can be more fully immersed in the story presented by the movie. Similarly, localization of audio signals can provide for more realistic training environments. For example, law enforcement personnel could use a video-based trainer that implements localization of audio signals to train for law enforcement scenarios where the locations of various actors and other objects are important. Localization of the sounds emitted by these actors and object would allow the trainee to more accurately interact with the training program.

A common method for localization of sounds is to read the same audio data twice from an audio source to generate two separate audio channels offset from each other, thereby providing an inter-aural time delay that can be used by the human auditory system to perceive a location for the sound (audio signal). However, the transmission of the two separate audio signals introduces a number of difficulties. One difficulty is that the traffic over a transmission medium used to transmit the two channels may be doubled as a result of two channels being transmitted rather than one. Similarly, two separate first-in, first-out (FIFO) buffers may be needed to buffer the two separate audio channels, thereby increasing the cost and/or complexity of implementation of this common method. Additionally, this method may not work for stereo-interleaved audio signals, as the stereo property of the audio data may introduce errors when implementing this common method.

Given these limitations, as discussed, it is apparent that a method and/or system for localization and motionization of audio signals would be beneficial.

### BRIEF DESCRIPTION OF THE DRAWINGS

Various objects, advantages, features and characteristics of the present invention, as well as methods, operation and functions of related elements of structure, and the combination of parts and economies of manufacture, will become apparent upon consideration of the following description and claims with reference to the accompanying drawings, all of which form a part of this specification.

FIG. 1 is a diagram illustrating an inter-aural time delay effect according to at least one embodiment of the present invention;

FIG. 2 is a block diagram illustrating a virtual localization system according to at least one embodiment of the present invention;

FIG. 3 is a block diagram illustrating a circular buffer implemented by the virtual localization system of FIG. 2 according to at least one embodiment of the present invention;

FIG. 4 is a diagram illustrating a method for applying a Doppler effect modification according to at least one embodiment of the present invention; and

FIG. 5 is a flow diagram illustrating a method for virtual localization/motionization of an audio signal according to at least one embodiment of the present invention.

### DETAILED DESCRIPTION OF THE FIGURES

In accordance with at least one embodiment of the present invention, an audio data representative of an audio signal is stored in a buffer. A first set of data is read from a first buffer location of the buffer. A second set of data is read from a second buffer location different from the first buffer location, where the difference between the first location and the second location is representative of an inter-aural time delay. One advantage in accordance with a specific embodiment of the present invention is that only one buffer is needed to implement an inter-aural time delay effect and/or a frequency modification. Another advantage is that less bandwidth is needed to transmit audio data. Yet another advantage is that stereo-interleaved audio data may be utilized by the present invention.

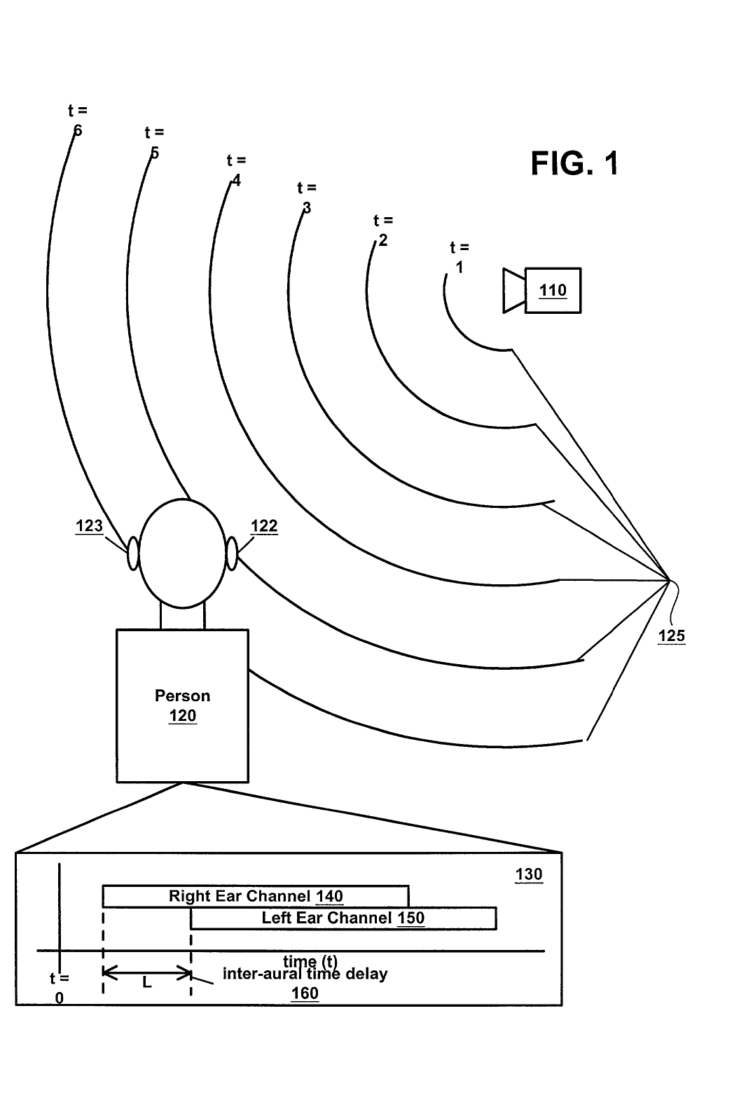

FIGS. 1-5 illustrate a system for virtual localization and/or motionization of a single audio signal, as well as a method for its use. The audio signal, represented by data, such as an audio file or streaming audio data, is transmitted from an audio source, such as an MP3 player, to an audio processing system. The audio processing system, in one embodiment, buffers the audio data in a single buffer, such as a circular buffer. As the data is buffered, one or more sample rate conversion units read data from different locations of the buffer and process the data to generate two or more processed channels. In at least one embodiment, the difference between the locations of the buffer being read at a given instant for each channel is representative of an inter-aural time delay, which can be used to provide a “virtual location” to the audio signal. In one embodiment, a first set of data is read from a first buffer location of the circular buffer to generate a first channel of audio data, while at the same time, a second set of data is read from a second buffer location, different from the first buffer location, to generate a second channel of audio data. The difference between the two buffer locations, in one embodiment, is representative of a virtual inter-aural time delay. The virtual inter-aural time delay, in at least one embodiment, includes a delay that represents an amount of time between the data being simultaneously accessed for the different audio channels that is interpreted by the human auditory system to provide a “virtual location” when the audio data is played. Similarly, a frequency modification process can be applied to either or all of the unprocessed channels to generate a “virtual motion” effect. For example, in one embodiment, a Doppler effect modification is applied to each of the unprocessed channels to create the perception of motion of a sound source represented by the audio signal. After applying the Doppler effect modification, the channels can be output to two or more audio output devices, such as speakers or headphones, or they can be stored in a storage device, such as in an audio file stored on a compact disc.

Referring now to FIG. 1, an inter-aural time delay effect resulting from a person's perception of sound emitted from a sound source is illustrated according to at least one embodiment of the present invention. Sound emitted from a sound source (sound source 110), such as sound emitted by audio speakers, musical instruments, or a person speaking, propagates through a medium, such as air, to person 120. Unless the right ear (right ear 122) and left ear (left ear 123) of person 120 are equidistant from sound source 110, there normally is a time delay between when the sound emitted from sound source 110 is perceived by right ear 122 and when it is perceived by left ear 123. As illustrated in FIG. 1, sound source 110 is located to the right of person 120, hence any sound emitted from audio source 110 will be perceived by right ear 122 before left ear 123. For example, at time t=5 (5 seconds, milliseconds, or microseconds, etc.), sound wave 125 emitted from sound source 110 reaches right ear 122, while at time t=6, sound wave 125 reaches left ear 123. Note that in the following discussion of FIGS. 1-5, it is assumed that location of sound source 110 is located closer to right ear 122 than to left ear 123 for ease of illustration.

The cochlea of right ear 122 converts sound wave 125 into electrical impulses propagated by the eighth nerve to the brain to generate right ear channel 140, as illustrated in chart 130. Similarly, left ear 123 generates left ear channel 150. The time delay, herein referred to as inter-aural time delay (ITD) 160, between when right ear channel 140 and left ear channel 140 are received and/or processed by the brain of person 120, in this example, can be used by the human auditory system of person 120 for localization of sound source 110 in three-dimensional (3-D) space. Note that, in general, the physiological composition of the auditory system of person 120 often results in a natural inter-aural time delay between right ear 122 and left ear 123 even when sound wave 125 reaches right ear 122 and left ear 123 simultaneously. Accordingly, in at least one embodiment, any subsequent reference to inter-aural time delay 160 can incorporate the time delay caused by the location of audio source 110 as well as the time delay resulting from the physiology the auditory system of person 120 unless otherwise noted.

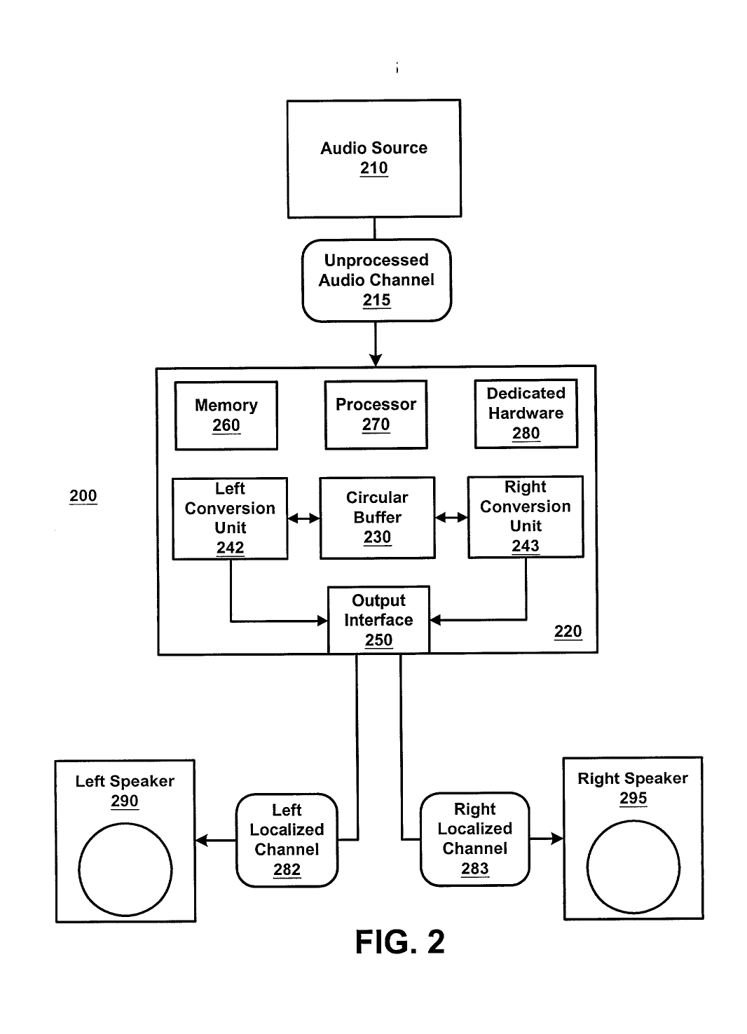

Referring to FIG. 2, a system for virtual localization of an audio signal using an inter-aural time delay effect is illustrated according to at least one embodiment of the present invention. Virtual localization system 200 includes audio source 210, audio processing system 220, left speaker 290 and right speaker 295. Audio processing system 220 includes circular buffer 230, left sample rate conversion unit 242, right sample rate conversion unit 243, output interface 250, memory 260, and processor 270. Audio processing system 220 can further include dedicated hardware 280. Virtual localization system 200 can be implemented using software or hardware, or a combination thereof. For example, virtual localization system 200 could be implemented as part of a graphics chip, a sound card for a computer, an application specific integrated circuit (ASIC), combinational logic, and the like.

In at least one embodiment, audio source 210 transmits audio data representative of one or more audio signals to audio processing system 220. The audio data can include stereo audio data, mono audio data, and the like. Audio source 210 can include any number of types of audio sources or players, such as a compact disc player or an Motion Picture Experts Group Layer 3 (MP3) player, streaming audio data transmitted over the Internet or other network, and the like. In one embodiment, audio data transmitted from audio source 210 is transmitted to audio processing system 220 in the form of unprocessed audio channel 215, wherein the audio data is representative of one or more audio signals. In one embodiment, unprocessed audio channel 215 includes audio data in a digital format. In another embodiment, unprocessed audio channel 215 includes audio data in an analog format. In this case, audio processing system 220 generally includes an analog-to-digital converter (ADC) to convert unprocessed audio channel 215 from an analog format to a digital format.

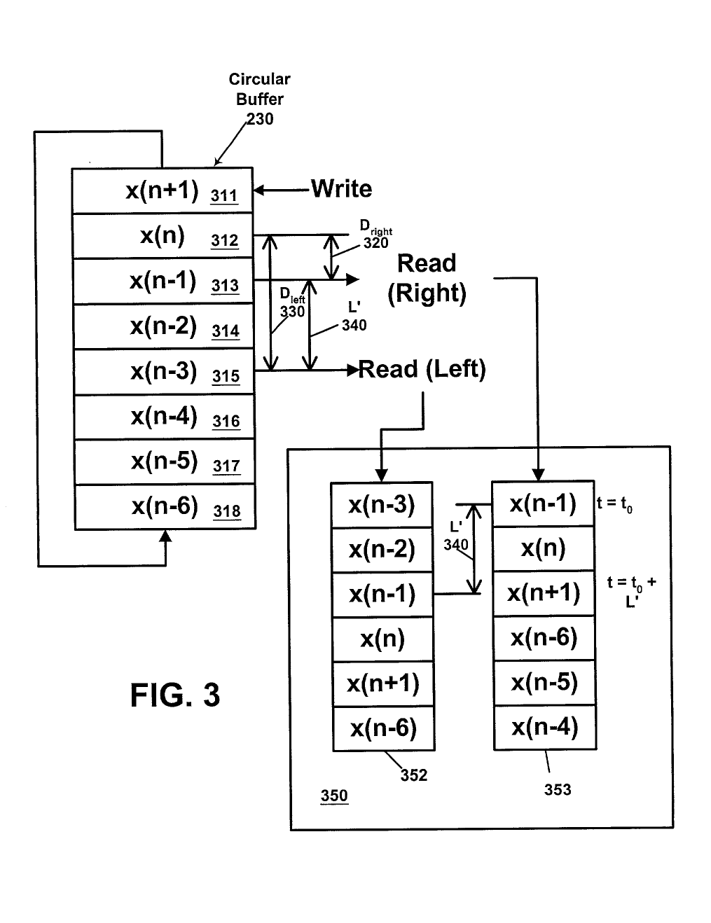

Audio processor 220, in one embodiment, buffers unprocessed audio channel 215 using circular buffer 230. Circular buffer 230 can include a circular buffer implemented in memory 260, where memory 260 can include random access memory, cache, a storage device, and the like. Alternately, circular buffer 230 can be implemented using a specific hardware component, such as an application specific integrated circuit (ASIC). Circular buffer 230, in one embodiment, implements a first-in, first-out (FIFO) architecture as well as a circular structure, wherein the oldest buffered element is overwritten by new data when circular buffer 230 is full. Circular buffer 230 is discussed in greater detail with reference to FIG. 3.

Left sample rate conversion unit 242, herein referred to as left conversion unit 242, in one embodiment, reads one or more values stored in one or more buffer elements from circular buffer 230 starting at a first location and processes the one or more values. Processes performed by left conversion unit 242 can include, but are not limited to, modifying the playback rate (generally as a result of the differences in input sample rates), frequency modification, such as a Doppler effect modification, and the like. Similarly, right sample rate conversion unit 243, herein referred to as right conversion unit 243, in parallel with left conversion unit 242, reads one or more values stored in one or more buffer elements from circular buffer 230 starting a second location. Right conversion unit 243 then processes the one or more buffer elements as with left conversion unit 242. As discussed in greater detail subsequently, the difference between the first location and the second location of circular buffer 230, in one embodiment, is representative of an inter-aural time delay (inter-aural time delay 160, FIG. 1). Left conversion unit 242 and/or right conversion unit 243 can be implemented in hardware, software, or a combination thereof. Note that the operations of left conversion unit 242 and right conversion unit 243 can be performed by a single conversion unit, where the bandwidth capability of the single unit of a speed sufficient enough to process both channels in real-time manner.

The results of the operations of left conversion unit 242 and right conversion unit 243, in one embodiment, are transmitted to output interface 250, where the results are formatted into a desired format for output. For example, output interface 250 could include a digital-to-analog converter (DAC) to convert the results of conversion units 242 and 243 from a digital format to an analog format. Output interface 250 could also provide other functions, such as filtering, impedance matching, and the like.

Output interface 250, after any necessary formatting or conversion, outputs the results of left conversion unit 242 as left localized channel 282 and the results of right conversion unit 243 as right localized channel 283. In one embodiment, left localized channel 282 and right localized channel 283 together form a representation of unprocessed audio channel 215 having a sense of location and motion. As a result of the inter-aural time delay (inter-aural time delay 160, FIG. 1) caused by the difference between the locations of circular buffer 230 read at a given time by left conversion unit 242 and right conversion unit 243, the sounds (audio signal) represented by unprocessed audio channel 215 can be perceived by the human auditory system as having a specific location in 3-D space when output through two audio out put devices, such as left speaker 290 and right speaker 295, herein referred to as “virtual localization”. Additionally, the sounds represented by unprocessed audio channel 215 can also be perceived as having motion, herein referred to as “virtual motionization”, when a frequency modulation process is applied, such as a Doppler effect modification.

Alternately, instead of outputting left localized channel 282 to left speaker 290 and right localized channel 283 to right speaker 295, left localized channel 282 and right localized channel 283 can be stored or recorded in a storage device, such as in a file on a hard disk or compact disc. In one embodiment, the functions of one or more of circular buffer 230, conversion units 242, 243, and output interface 250 are implemented, in whole or in part, as software. For example, a set of executable instructions that represent the functions of conversion units 242, 243 could be stored in memory 260, from which they can be retrieved and executed by processor 270, which can include a microprocessor, a programmable logic array, an ASIC, etc. In another embodiment, one or more elements of audio processing system 220 are implemented, in whole or in part, by dedicated hardware 280. Dedicated hardware 280 can include various types of hardware, such as an ASIC, combinational logic circuitry, etc. Note that although audio processing system 220, as illustrated in FIG. 2, outputs only two audio channels (left localized channel 282 and right localized channel 283), in at least one embodiment, more than two audio channels may be generated and output by audio processing system 220. For example, audio processing system 220 could include a third sample rate conversion unit (not shown) to generate and process a center audio channel from circular buffer 230 which may then be output to a center speaker (not shown).

Referring to FIG. 3, a method for virtual localization is illustrated in accordance with at least one embodiment of the present invention. As discussed previously, in one embodiment, circular buffer 230 includes a FIFO buffer with a circular architecture having a plurality of buffer elements. For ease of illustration, on embodiment of circular buffer 230 having eight buffer elements (buffer elements 311-318) is illustrated. Note that, in other embodiments, circular buffer 230 may include fewer or more buffer elements as appropriate. Buffer elements 311-318 may be implemented as locations in system memory (memory 260, FIG. 2), as elements of a processor or disk cache, as dedicated buffer hardware (dedicated hardware 280, FIG. 2), and the like. It will be appreciated that the number of buffer elements 311-318 utilized by circular buffer 230 is generally limited by the amount of available memory or cache.

Circular buffer 230, in one embodiment, buffers data from unprocessed audio channel 215 as it is transmitted to audio processing system 220 from audio source 210 (FIG. 2). In this case, each datum of unprocessed audio channel 215 generally represents an audio signal at a discrete point in time. For example, unprocessed audio channel 215 could include a streaming set of 16-bit datum, where each 16-bit datum represents a one millisecond digitized portion of an audio signal represented by unprocessed audio channel 215. Channel buffer 230 writes each datum value to one of buffer elements 311-318 in sequence as each datum value is received. As illustrated, each datum received by circular buffer 230 is stored starting from the bottom of circular buffer 230 (buffer element 318) until a value is stored at buffer element 311. After a datum is stored in buffer element 311, circular buffer 230 “circles back” to buffer element 318 and continues the cycle.

As discussed previously, in at least one embodiment, one or more sample rate conversion units (conversion units 242 and 243, FIG. 2) read from circular buffer 230 at different locations in the buffer to generate two or more audio channels (localized channels 282, 283, FIG. 2). As illustrated in chart 350, right unmodified channel 353 (a subset of the audio data stored in circular buffer 230) can be generated by starting at a first location of circular buffer 230 and reading from buffer elements 311-318 in a circular sequence. At the same time, left unmodified channel 352 (another subset of the audio data stored in circular buffer 230) can be generated by starting at a second location and reading from buffer elements 311-318 in the same circular sequence. The difference between the first location and the second location, in one embodiment, is representative of an inter-aural time delay (virtual inter-aural time delay 340) used for virtual localization of unprocessed audio channel 215 (FIG. 2). For example, if right unmodified channel 353 starts at buffer element 313 and continues on to buffer elements 312, 311, 318, 317, and so on, while left unmodified channel 352 starts at the same time at buffer element 315 and in the same sequence, there is a delay of two buffer elements between when buffer element 311 is read for right unmodified channel 353 and when it is read for left unmodified channel 352. In this case, the two buffer element difference is representative of virtual inter-aural time delay 340. For example, a buffer element (buffer elements 311-318) is read every 5 milliseconds, there would be a 10 millisecond time delay (two buffer element delay*5 ms/buffer) between right preprocessed channel 353 and left unmodified channel 352. The 10 millisecond time delay between channels 352, 353 can then be used by the human auditory system for virtual localization of an audio signal represented by channels 352, 353.

In at least one embodiment, a delay exists between the time when the most recent datum from unprocessed audio channel 215 (FIG. 2) is buffered and when that same datum is read for unmodified channels 352, 353. The delay, measured in number of buffer elements, for right unmodified channel 353 is represented by right delay (D_{right}) 320 and the delay for left unmodified channel 352 is represented by left delay (D_{left}) 330. The virtual inter-aural time delay, in one embodiment, be described as the difference between D_{right} and D_{left}, or L′=|D_{left-D}_{right}|. It will be appreciated that either D_{right} 320 and/or D_{left} 330 could be zero.

Virtual inter-aural delay (L′) 340 can be determined or generated in a number of ways. For example, in one embodiment, a value for L′ 340 is transmitted as part of unprocessed audio channel 215 (FIG. 2). In this case, audio processing system 220 can receive a value for L′ 340 from audio source 210 (FIG. 2) and calculate the equivalent number of buffer elements (buffer elements 311-318) needed between buffer reads for right unmodified channel 353 and left unmodified channel 352 at a given point in time. For example, if the value for L′ 340 is 10 microseconds and each of buffer elements 311-318 represents 2.5 microseconds of an audio signal, there should be 4 buffer elements (10 ms/2.5 μs per buffer element) between the read location for right unmodified channel 353 and the read location for left-preprocessed channel 352 at a given point in time. Note that, in at least one embodiment, the value for L′ 340 can vary. In this case, the equivalent number of buffer elements needed to implement L′ 340 can be determined as a new value for L′ 340 is received. Alternately, L′ 340 could be pre-determined by one or more elements of virtual localization system 200 (FIG. 2).

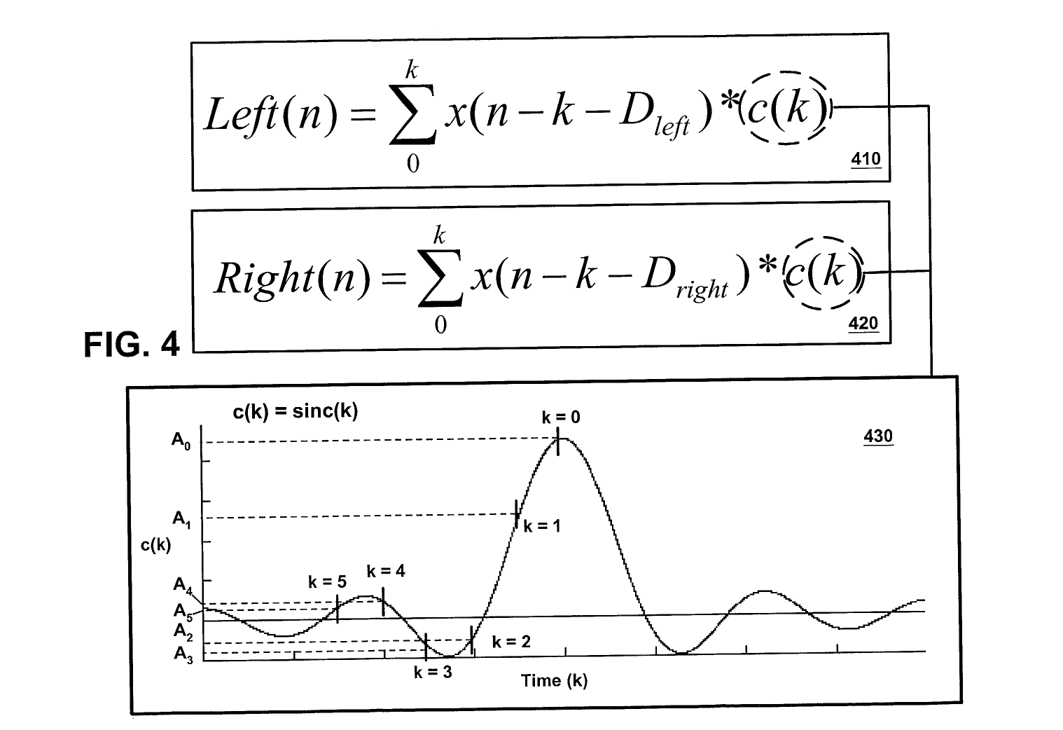

Referring to FIG. 4, a method for applying a Doppler effect modification is illustrated according to at least one embodiment of the present invention. As discussed previously, one or both of conversion units 242, 243 can perform one or more frequency modification processes. In one embodiment, a Doppler effect modification is applied to either or both of unmodified channels 352, 353 (FIG. 3). For example, unprocessed audio channel 215 could include an audio signal representative of a jet plane flying overhead. In this case, it could be desirable to provide virtual motionization in addition to virtual localization of the audio signal representative of the moving jet plane. By applying a Doppler effect modification in addition to virtual inter-aural time delay 340 (FIG. 3), a sense of motion (such as flying overhead) to the sound of the jet plane can be perceived by the human auditory system in addition to a sense of location of the jet plane.

In at least one embodiment, Doppler equation 410 used to apply a Doppler effect modification to right unmodified channel 353 (FIG. 3) is as follows:

$$R i g h t ( n ) = {\sum }_{0}^{k} x ( n - k - {D}_{right} ) * c ( k )$$

where Right(n) represents the value resulting from the application of a Doppler effect at buffer location n, x(n−k−D_{right}) represents the value stored in the buffer element at location x−k−D_{right}, k is the number of elements stored previous to the datum stored at buffer location n that are still located in circular buffer 230 (i.e. have not been overwritten), D_{right} is right time delay 320 (FIG. 3), and c(k) represents a value of a Doppler shift function c evaluated at point k. Similarly, Doppler equation 420 can be used to apply a Doppler effect modification to left unmodified channel 352. Doppler equation 420 is as follows:

$$L e f t ( n ) = {\sum }_{0}^{k} x ( n - k - {D}_{left} ) * c ( k )$$

where Left(n) represents the value resulting from the application of a Doppler effect at buffer location n, x(n−k−D_{left}) represents the value stored in the buffer element at location x−k−D_{left}, k is the number of elements stored previous to the datum stored at buffer location n that are still located in circular buffer 230 (i.e. have not been overwritten), D_{left} is left time delay 330 (FIG. 3), and c(k) represents a value of a Doppler shift function c evaluated at point k.

In at least one embodiment, the Doppler effect function c is represented by a sinc function. In this case, c(k) represents the amplitude of the sinc function at point k. For example, c(k=0)=A₀, c(k=1)=A₁, c(k=2)=A₂, and so on. The sinc function, as applied with reference to Doppler equations 410 and 420, is generally useful in applying an accurate Doppler frequency shift to give an audio signal virtual motionization. As with virtual inter-aural time delay 340, the properties of the sinc function used for c(k) can be predetermined or provided by an element of virtual localization system 200. For example, if the sinc function has the form of c(k)=A*sinc(B*k+C)+D, the values of A, B, C, and/or D can be provided by audio source 210 as part of unprocessed audio channel 215 or separately from audio channel 215, etc. Alternately, the values could be predetermined by audio processing system 220.

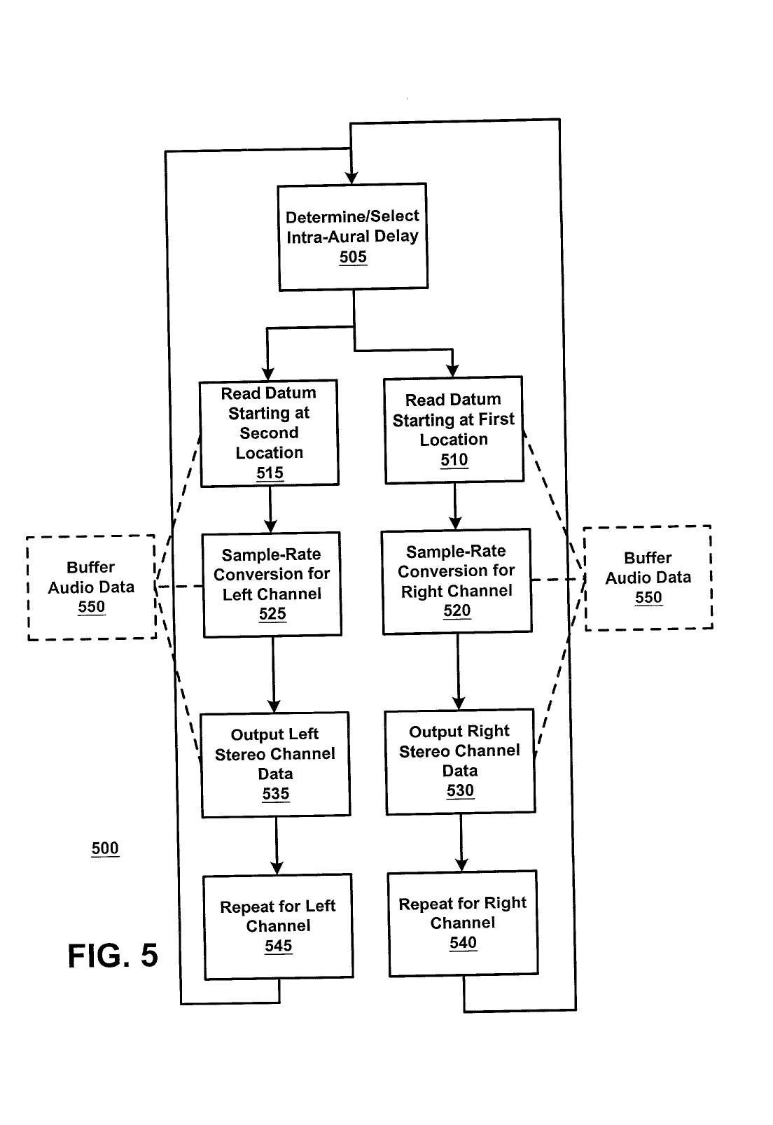

Referring next to FIG. 5, a method for utilizing virtual localization system 200 for virtual localization and movement of an audio signal is illustrated according to at least one embodiment of the present invention. Method 500 initiates with step 505, wherein a value for virtual inter-aural time delay (ITD) 340 is determined or selected. As discussed previously, the value for virtual ITD 340 can be transmitted from audio source 210 (FIG. 2), pre-determined by audio processing system 220 using empirical or other means, and the like. Recall that, in at least one embodiment, virtual ITD 340 is represented by the difference between the locations of circular buffer 230 (FIG. 2) from which two or more unmodified channels 352, 353 (FIG. 3) are read and generated. Accordingly, audio processing system 220 can convert virtual ITD 340 from a time value to a value, measured in number of buffer elements 311-318 (FIG. 3), that represents this difference in locations. This is generally necessary when there is a sample rate conversion performed by audio processing system. For example, if conversion units 242, 243 (FIG. 3) perform a 3:2 sample rate conversion in addition to virtual localization and Doppler effect processing, audio processing system 120 normally would need to adjust virtual ITD 340 to conform to the new sample rate.

In step 510, data is read by right conversion unit 243 (FIG. 2) from a first location (one of buffer element 311-318) of circular buffer 230 (FIG. 2) and is added to right unmodified channel 353. Similarly, a datum is read by left conversion unit 242 (FIG. 2) from a second location of circular buffer 230 and is added to right unmodified channel 353. In at least one embodiment, data may be read from circular buffer 230 using direct memory access (DMA).

In step 520, one or more processes are performed on right unmodified channel 353. As discussed previously, in one embodiment, Doppler equation 410 (FIG. 4) is applied to right unmodified channel 353 to create a Doppler effect (i.e. to give the sense of motion). In other embodiments, other processes, such as filtering, sample rate conversion, and the like, are performed on right unmodified channel 353. Likewise, instep 525, one or more processes are performed on left unmodified channel 352. For example, Doppler equation 420 could be applied to left unmodified channel 352 to create a Doppler effect. Note that the same or similar processes may be applied in both steps 520 and 525, as may different processes.

In step 530, the results of any processing performed on right unmodified channel 353 in step 520 are formatted as appropriate by output interface 250 (FIG. 2) and then output as right localized channel 283. Similarly, in step 535, the results of any processing performed on left unmodified channel 353 in step 525 are formatted and output by output interface 250 as left localized channel 282. Types of formatting performed by output interface 250 can include digital-to-analog conversion, power amplification, impedance matching, and the like. Recall that right localized channel 283 and/or left localized channel 282, in one embodiment, are transmitted to two or more audio output devices, such as speakers 290, 295, for conversion into sound. Alternately, right localized channel 283 and/or left localized channel 282 could be stored or recorded on a storage device, such as a compact disc.

In step 540, steps 505-530 can be repeated for the next location (buffer element 311-318) in circular buffer 230 to be accessed by right conversion unit 243. For example, as discussed with reference to FIG. 2, buffer elements 311-318, in one embodiment, are accessed in a circular order. For example, if the location read by right conversion unit 243 in step 510 is buffer element 311, the next buffer element accessed in the next cycle of steps 510-530 is buffer element 318. Similarly, if the previous buffer element accessed is buffer element is buffer element 317, the next buffer element to be accessed would be buffer element 316, and so on. Likewise, in step 545, steps 505-545 can be repeated for the next location in circular buffer 230 to be accessed by left conversion unit 242.

In at least one embodiment, audio processing system 220 (FIG. 2) processes data from unprocessed audio channel 215 (FIG. 2) in a real-time fashion as it is received by audio processing system 220. Accordingly, in step 550, unprocessed audio channel 215 is buffered in circular buffer 230 as the data is received. Note that, in one embodiment, buffering unprocessed audio channel 215 (step 550) can occur before, during, and/or after any step of method 500. For example, data from unprocessed audio channel 215 could be buffered while localized channels 352, 353 (FIG. 3) are output by output interface 250 (FIG. 2). Since circular buffer 230, in one embodiment, includes a circular buffer with a finite number of buffer elements 311-318, if there is more data in unprocessed audio channel 215 than space in circular buffer 230, previously buffered data may be overwritten by more recent data from unprocessed audio channel 215. It will be appreciated that care must be taken to prevent data being used or to be used by conversion units 242, 243 is not overwritten by new data to be buffered until it is no longer needed. Accordingly, there generally is a dynamic trade-off between a maximum virtual ITD 340 and the amount of buffering that can be performed by circular buffer 230.

Application of method 500 to an audio channel (unprocessed audio channel 215, FIG. 2), in one embodiment, results in two or more audio channels (localized channels 282, 283) which, when used together, cause the auditory system of a person (person 120, FIG. 1) to perceive a virtual location and/or motion in 3-D space for the audio source represented by the single audio channel.

The various functions and components in the present application may be implemented using an information handling machine such as a data processor, or a plurality of processing devices. Such a data processor may be a microprocessor, microcontroller, microcomputer, digital signal processor, state machine, logic circuitry, and/or any device that manipulates digital information based on operational instruction, or in a predefined manner. Generally, the various functions, and systems represented by block diagrams are readily implemented by one of ordinary skill in the art using one or more of the implementation techniques listed herein. When a data processor for issuing instructions is used, the instruction may be stored in memory. Such a memory may be a single memory device or a plurality of memory devices. Such a memory device may be read-only memory device, random access memory device, magnetic tape memory, floppy disk memory, hard drive memory, external tape, and/or any device that stores digital information. Note that when the data processor implements one or more of its functions via a state machine or logic circuitry, the memory storing the corresponding instructions may be embedded within the circuitry that includes a state machine and/or logic circuitry, or it may be unnecessary because the function is performed using combinational logic. Such an information handling machine may be a system, or part of a system, such as a computer, a personal digital assistant (PDA), a hand held computing device, a cable set-top box, an Internet capable device, such as a cellular phone, and the like.

One of the implementations of the invention is as sets of computer readable instructions resident in the random access memory of one or more processing systems configured generally as described in FIGS. 1-5. Until required by the processing system, the set of instructions may be stored in another computer readable memory, for example, in a hard disk drive or in a removable memory such as an optical disk for eventual use in a CD drive or DVD drive or a floppy disk for eventual use in a floppy disk drive. Further, the set of instructions can be stored in the memory of another image processing system and transmitted over a local area network or a wide area network, such as the Internet, where the transmitted signal could be a signal propagated through a medium such as an ISDN line, or the signal may be propagated through an air medium and received by a local satellite to be transferred to the processing system. Such a signal may be a composite signal comprising a carrier signal, and contained within the carrier signal is the desired information containing at least one computer program instruction implementing the invention, and may be downloaded as such when desired by the user. One skilled in the art would appreciate that the physical storage and/or transfer of the sets of instructions physically changes the medium upon which it is stored electrically, magnetically, or chemically so that the medium carries computer readable information. The preceding detailed description is, therefore, not to be taken in a limiting sense, and the scope of the present invention is defined only by the appended claims.

In the preceding detailed description of the figures, reference has been made to the accompanying drawings which form a part thereof, and in which is shown by way of illustration specific embodiments in which the invention may be practiced. These embodiments are described in sufficient detail to enable those skilled in the art to practice the invention, and it is to be understood that other embodiments may be utilized and that logical, mechanical, chemical and electrical changes may be made without departing from the spirit or scope of the invention. To avoid detail not necessary to enable those skilled in the art to practice the invention, the description may omit certain information known to those skilled in the art. Furthermore, many other varied embodiments that incorporate the teachings of the invention may be easily constructed by those skilled in the art. Accordingly, the present invention is not intended to be limited to the specific form set forth herein, but on the contrary, it is intended to cover such alternatives, modifications, and equivalents, as can be reasonably included within the spirit and scope of the invention. The preceding detailed description is, therefore, not to be taken in a limiting sense, and the scope of the present invention is defined only by the appended claims.

What is claimed is:

1. A method comprising the steps of:
storing an audio data representative of an audio signal in a buffer;
reading a first set of data from a first buffer location; and
reading a second set of data from a second buffer location different from the first buffer location, where the difference between the first location and the second location is representative of an inter-aural time delay.

2. The method of claim 1, wherein the buffer is a circular buffer.

3. The method of claim 1, further including the steps of:
performing a first frequency modification on the first set of data to generate a first audio channel; and
performing a second frequency modification on the second set of data to generate a second audio channel.

4. The method of claim 3, wherein the first channel and the second channel together form a virtual localization of the audio data.

5. The method of claim 3, wherein the first channel and the second channel together form a virtual motionization of the audio data.

6. The method of claim 3, wherein the step of performing a frequency modification includes the step of performing a Doppler effect modification.

7. The method of claim 6, wherein the step of performing a Doppler effect modification includes modifying each buffer location (n) of a channel by:
$$C h a n n e l ( n ) = {\sum }_{0}^{k} x ( n - k - {D}_{channel} ) * c ( k )$$
where k is a number of locations in the buffer having values previous to the value stored in location n, D_{channel} is a channel time delay, x(n−k−D_{channel}) is a value of the datum stored at location n−k−D_{channel} of the buffer, c(k) is a value of a Doppler shift equation at point k, and Channel(n) is a value associated with the data stored at buffer location n after the Doppler effect modification.

8. The method of claim 7, wherein the Doppler shift equation, c(k), includes a sinc function.

9. A method comprising the steps of:
receiving a first set of audio data at a first time; and
receiving the first set of data at a second time different from the first time, wherein a difference between the first time and the second time is representative of an inter-aural time delay.

10. The method of claim 9, further including the steps of:
performing a first frequency modification on the first set of data received at the first time to generate a first audio channel; and
performing a second frequency modification on the first set of data received at the second time to generate a second audio channel.

11. The method of claim 10, wherein the first channel and the second channel together form a virtual localization of the audio data.

12. The method of claim 10, wherein the first channel and the second channel together form a virtual motionization of the audio data.

13. The method of claim 10, wherein the step of performing a frequency modification includes the step of performing a Doppler effect modification.

14. The method of claim 13, wherein the step of performing a Doppler effect modification includes modifying each buffer location (n) of a channel by:
$$C h a n n e l ( n ) = {\sum }_{0}^{k} x ( n - k - {D}_{channel} ) * c ( k )$$
where k is a number of locations in the buffer having values previous to the value stored in location n, D_{channel} is a channel time delay, x(n−k−D_{channel}) is a value of the datum stored at location n−k−D_{channel} of the buffer, c(k) is a value of a Doppler shift equation at point k, and Channel(n) is a value associated with the data stored at buffer location n after the Doppler effect modification.

15. The method of claim 14, wherein the Doppler shift equation, c(k), includes a sinc function.

16. A method comprising the steps of:
reading a first subset of data from a set of audio data stored in a circular buffer, wherein the first subset of data is read starting at a first buffer location; and
reading a second subset of data from the set of audio data stored in the circular buffer, wherein the second subset of data is read starting at a second buffer location, and where a difference between the first location and the second location is representative of an inter-aural time delay.

17. The method of claim 16, further including the step of buffering the set of audio data in the circular buffer.

18. The method of claim 16, further including the steps of:
performing a Doppler effect modification on the first subset of data to generate a first stereo channel; and
performing a Doppler effect modification on the second subset of data to generate a second stereo channel.

19. The method of claim 18, further comprising the step of outputting the first stereo channel to a first audio output device and the second stereo channel to a second audio output device.

20. The method of claim 18, wherein the first channel and the second channel together form virtual localization of the audio data.

21. The method of claim 18, wherein the first channel and the second channel together form virtual motionization of the audio data.

22. The method of claim 18, wherein the step of performing a Doppler effect modification includes modifying each buffer location (n) of a channel by:
$$C h a n n e l ( n ) = {\sum }_{0}^{k} x ( n - k - {D}_{channel} ) * c ( k )$$
where k is a number of locations in the buffer having values previous to the value stored in location n, D_{channel} is a channel time delay, x(n−k−D_{channel}) is a value of the datum stored at location n−k−D_{channel} of the buffer, c(k) is a value of a Doppler shift equation at point k, and Channel(n) is a value associated with the data stored at buffer location n after the Doppler effect modification.

23. The method of claim 22, wherein the Doppler shift equation, c(k), includes a sinc function.

24. A system comprising:
a processor;
memory operably coupled to said processor;
a buffer; and
a program of instructions capable of being stored in said memory and executed by said processor, said program of instructions to manipulate said processor to:
store an audio data representative of an audio signal in said buffer;
read a first set of data from a first buffer location of said buffer;
read a second set of data from a second buffer location different from the first buffer location, where the difference between the first buffer location and the second buffer location is representative of an inter-aural time delay.

25. The system of claim 24, wherein said buffer is implemented in said memory.

26. The system of claim 24, wherein said buffer includes a circular buffer.

27. The system of claim 24, wherein said program of instructions further includes instructions to manipulate said processor to:
perform a first frequency modification on the first set of data to generate a first audio channel; and
perform a second frequency modification on the second set of data to generate a second audio channel.

28. The system of claim 27, wherein the first channel and the second channel together form a virtual localization of the audio data.

29. The system of claim 27, wherein the first channel and the second channel together form a virtual motionization of the audio data.

30. The system of claim 27, wherein the instructions to perform a frequency modification includes instructions to manipulate said processor to perform a Doppler effect modification.

31. The system of claim 30, wherein the instructions to perform a Doppler effect modification includes modifying each buffer location (n) of a channel by:
$$C h a n n e l ( n ) = {\sum }_{0}^{k} x ( n - k - {D}_{channel} ) * c ( k )$$
where k is a number of locations in the buffer having values previous to the value stored in location n, D_{channel} is a channel time delay, x(n−k−D_{channel}) is a value of the datum stored at location n−k−D_{channel} of the buffer, c(k) is a value of a Doppler shift equation at point k, and Channel(n) is a value associated with the data stored at buffer location n after the Doppler effect modification.

32. The system of claim 31, wherein the Doppler shift equation, c(k), includes a sinc function.

33. A computer readable medium tangibly embodying a program of instructions, said program of instructions including instructions to manipulate a processor to:
store an audio data representative of an audio signal in said buffer;
read a first set of data from a first buffer location of said buffer; and
read a second set of data from a second buffer location different from the first buffer location, where the difference between the first buffer location and the second buffer location is representative of an inter-aural time delay.

34. The computer readable medium of claim 33, wherein said program of instructions further includes instructions to manipulate said processor to:
perform a first frequency modification on the first set of data to generate a first audio channel; and
perform a second frequency modification on the second set of data to generate a second audio channel.

35. The computer readable medium of claim 34, wherein the first channel and the second channel together form a virtual localization of the audio data.

36. The computer readable medium of claim 34, wherein the first channel and the second channel together form a virtual motionization of the audio data.

37. The computer readable medium of claim 34, wherein the instructions to perform a frequency modification includes instructions to manipulate said processor to perform a Doppler effect modification.

38. The system of claim 37, wherein the instructions to perform a Doppler effect modification includes modifying each buffer location (n) of a channel by:
$$C h a n n e l ( n ) = {\sum }_{0}^{k} x ( n - k - {D}_{channel} ) * c ( k )$$
where k is a number of locations in the buffer having values previous to the value stored in location n, D_{channel} is a channel time delay, x(n−k−D_{channel}) is a value of the datum stored at location n−k−D_{channel} of the buffer, c(k) is a value of a Doppler shift equation at point k, and Channel(n) is a value associated with the data stored at buffer location n after the Doppler effect modification.

39. The computer readable medium of claim 38, wherein the Doppler shift equation, c(k), includes a sinc function.

40. A system comprising:
a circular buffer, wherein the circular buffer is to buffer a set of audio data;
a first sample rate conversion unit, wherein the first sample rate conversion unit is to read a first subset of the set of audio data from the circular buffer at a first location and to perform a frequency modification on the first subset to generate a first audio channel; and
a second sample rate conversion unit, wherein the second sample rate conversion unit is to read a second subset of the set of audio data from the circular buffer at a second location and to perform a frequency modification on the second subset to generate a second audio channel.

41. The system of claim 40, wherein the functions of the first sample rate conversion unit and the second sample rate conversion unit are performed by a single sample rate conversion unit.

42. The system of claim 40, wherein the difference between the first location and the second location is representative of an inter-aural time delay.

43. The system of claim 40, wherein the first audio channel and the second audio channel together represent a virtual localization of the buffered audio data.

44. The system of claim 40, wherein the first channel and the second channel together represent virtual motionization of the buffered audio data.

45. The system of claim 40, wherein the frequency modification performed by the first and second sample rate conversion units includes a Doppler effect modification.

46. The system of claim 45, wherein the Doppler effect modification includes modifying each buffer location (n) of a channel by:
$$C h a n n e l ( n ) = {\sum }_{0}^{k} x ( n - k - {D}_{channel} ) * c ( k )$$
where k is a number of locations in the buffer having values previous to the value stored in location n, D_{channel} is a channel time delay, x(n−k−D_{channel}) is a value of the datum stored at location n−k−D_{channel} of the buffer, c(k) is a value of a Doppler shift equation at point k, and Channel(n) is a value associated with the data stored at buffer location n after the Doppler effect modification.

47. The system of claim 46, wherein the Doppler shift equation, c(k), includes a sinc function.
